(19) United States
(12) Patent Application Publication
(10) Pub. No.: US 2015/0295886 A1
(43) Pub. Date: Oct. 15, 2015

(54) SYSTEM FOR IDENTIFYING CURRENT INTERNET PROTOCOL ADDRESS FOR A REMOTE COMPUTING DEVICE

(71) Applicants: Gangming Luo, Elmhurst, NY (US); Jonathan J. Kaufman, Brooklyn, NY (US)

(72) Inventors: Gangming Luo, Elmhurst, NY (US); Jonathan J. Kaufman, Brooklyn, NY (US)

(21) Appl. No.: 14/252,243

(22) Filed: Apr. 14, 2014

(51) Int. Cl. H04L 29/12; H04L 29/08

(52) U.S. Cl. CPC H04L 61/30; H04L 67/141

(57) ABSTRACT

A system is provided that provides a current interne protocol address associated with a remote computing device. The system includes a server configured for connection to the remote computing device over a first network and to a local computing device over a second network. The server has a computer program encoded thereon that includes code for: receiving a request for a resource from a web browser on the remote computing device and obtaining the current internet protocol address from the request. The program further includes code for providing the current internet protocol address to the local computing device.

### BACKGROUND OF THE INVENTION

a. Field of the Invention

This invention relates to the access and control of remote computing devices over a network. In particular, this invention relates to a system that provides the current internet protocol address for the remote computing device to facilitate connection to, and control of, the remote computing device.

b. Background Art

A computing device (e.g., a router, a personal computer, a cellular phone, etc.) is assigned an internet protocol address when the device connects to the public internet. The address is typically assigned by an internet service provider (e.g., Verizon). Internet service providers are allocated blocks of addresses from various internet registries operating under the auspices of the Internet Assigned Numbers Authority (IANA). Depending on which version of the internet protocol addressing system is in use (i.e. IPv4 or IPv6), the addresses comprise either thirty-two (32) bit numbers expressed in a “dotted decimal” notation (e.g., 192.0.2.53) or one hundred and twenty-eight (128) bit numbers expressed using hexadecimal strings (e.g., 2001:0db8:582:ae33::29).

Internet service providers (ISPs) typically assign a “dynamic” internet protocol address to computer devices that access the internet using the provider's services under the Dynamic Host Configuration Protocol (DHCP). A dynamic internet protocol address can change over time. ISPs use dynamic internet protocol addresses because doing so eliminates the need to assign and track individual addresses for each computing device and allows shared use of limited addresses (i.e., a computing device does not require an address when it is not connected to the network and the address may therefore be used by another computing device). Many ISPs will assign “static” internet protocol addresses (i.e., addresses that will not change over time), but charge customers additional (and often significant) fees. As a result, most residential and small businesses are assigned dynamic internet protocol addresses.

In recent years, computer software has been developed that permits remote access to computing devices through a network connection . Using this remote access software (e.g., the software known as Remote Desktop Connection from Microsoft Corporation or GoToMyPC from Citrix Systems, Inc.), a user can access and control a remote computing device from a local computing device over a network. For example, a user can access an office computing device from the user's home. The user interacts with the remote computing device in a virtually identical fashion to the interaction the user would have if the user were actually at the location of the remote computing device and using the device directly. Use of remote access software of the type described above requires that the internet protocol address of the remote computing device be known so that a proper connection can be made. In computing devices that are assigned dynamic internet protocol addresses, however, the internet protocol address may change.

In order to address the problem of dynamic internet protocol addresses and the impact on potential use of remote access software, systems have been developed that monitor the internet protocol address assigned to a remote computing device and communicate any changes over a network (e.g., the software known as “No-IP” offered by Vitalwerks Internet Solutions LLC d/b/a No-IP.com). Existing systems, however, require users to download and execute proprietary software on the remote computing device. Downloading and/or executing such software incurs costs on system resources (e.g., memory) and, more importantly, carries inherent security risks (e.g., providing access to files on the remote computing device) that may be created intentionally by malicious software providers or inadvertently by well-meaning software providers.

The inventors herein have recognized a need for a system for providing a current internet protocol address for a remote computing device that will overcome one or more of the above-identified deficiencies.

### BRIEF SUMMARY OF THE INVENTION

A system for providing access and control of remote computing devices over a network is provided. In particular, a system is provided that provides the current internet protocol address for the remote computing device to facilitate connection to, and control of, the remote computing device.

A system for providing a current internet protocol address associated with a remote computing device in accordance with one embodiment of the invention includes a server configured for connection to the remote computing device over a first network and a local computing device over a second network. The server has a computer program encoded thereon including code for receiving a request for a resource from a web browser on the remote computing device, obtaining the current internet protocol address from the request, and providing the current internet protocol address to the local computing device.

An article of manufacture in accordance with one embodiment of the invention includes a non-transitory computer storage medium having a computer program encoded thereon for providing a current internet protocol address associated with a remote computing device. The computer program includes code for receiving a request for a resource from a web browser on the remote computing device, obtaining the current internet protocol address from the request, and providing the current internet protocol address to a local computing device.

A method for providing a current internet protocol address associated with a remote computing device in accordance with one embodiment of the invention includes the steps of receiving a request for a resource from a web browser on the remote computing device over a first network and obtaining the current internet protocol address from the request. The method further includes the step of providing the current internet protocol address to a local computing device over a second network.

A system in accordance with the present invention is advantageous relative to conventional systems for providing internet protocol addresses assigned to remote computing devices because the inventive system does not require downloading and execution of proprietary software on the remote computing device. As a result, the inventive system requires less resources (e.g., memory on the remote computing device) and is more secure than conventional systems.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a diagrammatic view of a system for providing a current internet protocol address of a remote computing device in accordance with one embodiment of the present teachings.

FIGS. 2A-2B are screen displays illustrating the operation of the system of FIG. 1.

FIG. 3 illustrates an exemplary message providing the current internet protocol address to a local computing device.

### DETAILED DESCRIPTION OF EMBODIMENTS OF THE INVENTION

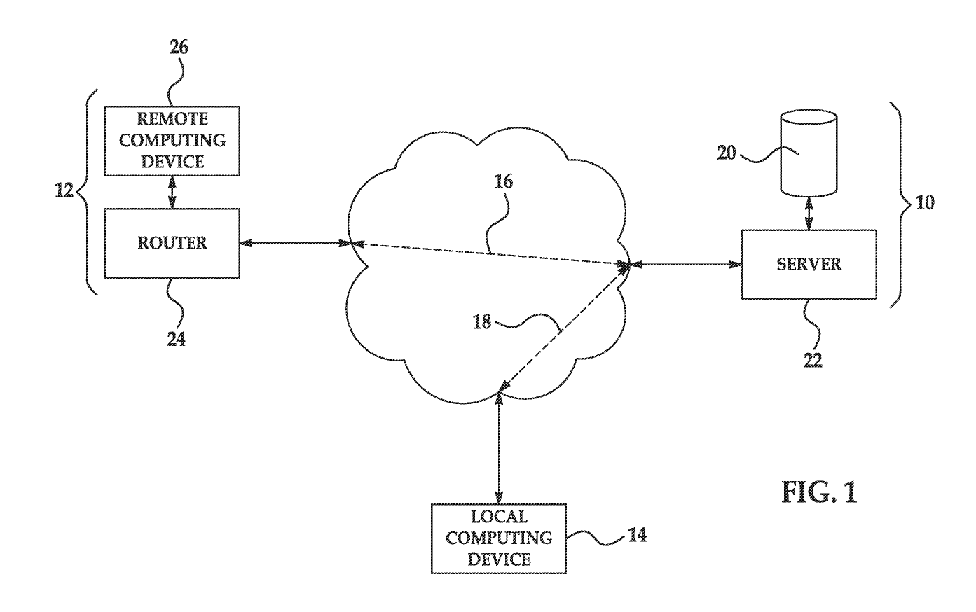

Referring now to the drawings wherein like reference numerals are used to identify identical components in the various views, FIG. 1 illustrates a system 10 for providing a current internet protocol address associated with a remote computing device 12 to a local computing device 14. As used herein, the term “remote” as applied to a computing device indicates that the device is one for which an internet protocol address is obtained and provided to another computing device. In accordance with one embodiment of the invention, a remote computing device will typically be one that, at certain points in time, is accessed by a user through a telecommunications network using another computing device as opposed to being accessed through a local input/output device such as a keyboard or mouse. As used herein, the term “local” as applied to a computer device indicates that the device is one that is provided with an internet protocol address from another computing device. A local computing device will typically be one that is accessed directly by a user using an input/output device (e.g. a display), but could alternatively be an “unmanned” device that receives the internet protocol address of the remote computing device and stores, displays and/or performs other actions in response to receipt of the address. Components of system 10 and devices 12, 14, may be connected to system 10 over networks 16, 18. System 10 may include a database 20 and a server 22.

Devices 12, 14 may comprise any of a wide variety of computing devices. As used herein, the term “computing device” is intended to refer to any machine that is configured to process data or information in accordance with a set of executable instructions. Accordingly, devices 12, 14 may comprise, for example, personal computers (including desktop, laptop and tablet computers), personal digital assistants, cellular communication devices (including “smartphones”), servers, routers or similar devices. Devices 12, 14 may include one or more programmable microprocessors and may include a central processing unit (CPU), memory, and one more input/output devices such as a keyboard, mouse, touch screen, display/monitor, camera, activators (e.g., switches, thermostats) and sensors (e.g., temperature, vibration, humidity). The displays may present a graphical user interface (GUI) to the user resulting in one or more of the screen displays described hereinbelow. Devices 12, 14 may further comprise a combination of two or more of such machines. For example, in accordance with one embodiment of the invention, device 12 comprises a router 24 and a personal computer 26 connected to router 24. Router 24 is provided to route packets of data between networks such as network 16 and a network (wired or wireless) connecting router 24 and computer 26 based on a routing table internal to router 24. Devices 12, 14 may be programmed in a conventional manner with various executable instructions (i.e. software) to perform a variety of tasks. In accordance with one aspect of the present invention, device 12 includes a web browser for requesting, obtaining and displaying information received over network 16 such as Internet Explorer by Microsoft Corp., Chrome by Google, Inc. or Firefox by Mozilla Corp. Each request issued by a web browser in device 12 includes the current internet protocol address of device 12 thereby allowing the recipient of the request (i.e., the server) to transmit information to device 12.

Networks 16, 18 establish communication links between devices 12, 14 and server 22 to enable an exchange of information between devices 12, 14 and server 22. Each of devices 12, 14 and server 22 may have a conventional network interface. Networks 16, 18 may each comprise portions of the public internet, a cellular telecommunications network, a local area network (LAN), wide area network (WAN), virtual private network (VPN) and/or other form of telecommunications network.

Database 20 provides data storage for server 22. Database 20 may employ a relational database management system (RDBMS) such as any of the open source systems MySQL, PostgreSQL, MariaDB, or the commercial systems SQL Server from Oracle Corp. or SQL Server from Microsoft Corp. Database 20 may be configured to provide a static and/or dynamic contact structure for server 22 and may be used to provide both intermediate information while server 22 executes operations and long-term storage of data. In accordance with one aspect of the invention, database 20 implements a data structure that may relate authentication information such as a user identifier and a password, contact information such as an electronic mail address and/or phone number (either of which may also serve as a user identifier), a device identifier, and an internet protocol address for a purpose described hereinbelow.

Server 22 monitors the internet protocol address for remote computing device 12 and provides the current internet protocol address for device 12 to local computing device 14 to, for example, enable remote access of device 12 from device 14. As used herein, the term “server” refers to a computing device coupled to a telecommunications network and configured by programming instructions (i.e., software) to provide services to other computing devices (including other servers). The server may include an operating system such as one of the operating systems based on the Linux or UNIX operating systems. In addition, or as an alternative to database 20, server 22 may also include an internal memory or database that may employ a database management system (DBMS) such as any of the open source systems MySQL, PostgreSQL, MariaDB, or the commercial systems SQL Server from Oracle Corp. or SQL Server from Microsoft Corp. The memory or database may be configured to provide a static and dynamic contact structure for server 22 and used to provide both intermediate information while server 22 executes operations and long-term storage of data. Server 22 may further include applications that configure server 22 to perform specific functions based on the intended user of server 22. The applications may be implemented using software development components (e.g., C or C++) and scripting languages such as PHP, Perl, Python and RoR (Ruby on Rails) to provide required functionality. It should be appreciated that the server-side software can be implemented in a number of ways that are used to generate dynamic content on web pages and web applications, as for example using Common Gateway Interface (CGI). Server 22 may also include an interface to provide a graphical and communications interface between server 22 and clients such as devices 12, 14. The interface may, for example, be configured to be hypertext transfer protocol (HTTP), eXtensible Markup Language (XML) or Simple Object Access Protocol (SOAP) compliant.

Server 22 is configured for connection to device 12 over network 16 and to device 14 over network 18. In accordance with the present invention, server 22 may be configured (encoded) with programming instructions from a computer program (i.e. software) to perform a method for providing the current internet protocol address of a remote computing device 12 to a local computing device 14. Server 22 may first be configured to receive a request for a resource from a web browser on device 12 and to obtain the current internet protocol address of device 12 from the request. A user of device 12 may use a web browser in a conventional manner to request information from server 22. Server 22 may comprise a web server configured to generate a website with a graphical user interface (GUI) as described in greater detail hereinbelow. Accordingly, the request may he made by the user by entering the address of the website (e.g., http://www.emailmyip.info) maintained on server 22 into the browser on device 12. The resulting request from the browser will include various information including the current internet protocol address of device 12 which is needed to allow server 22 to transmit information to device 12.

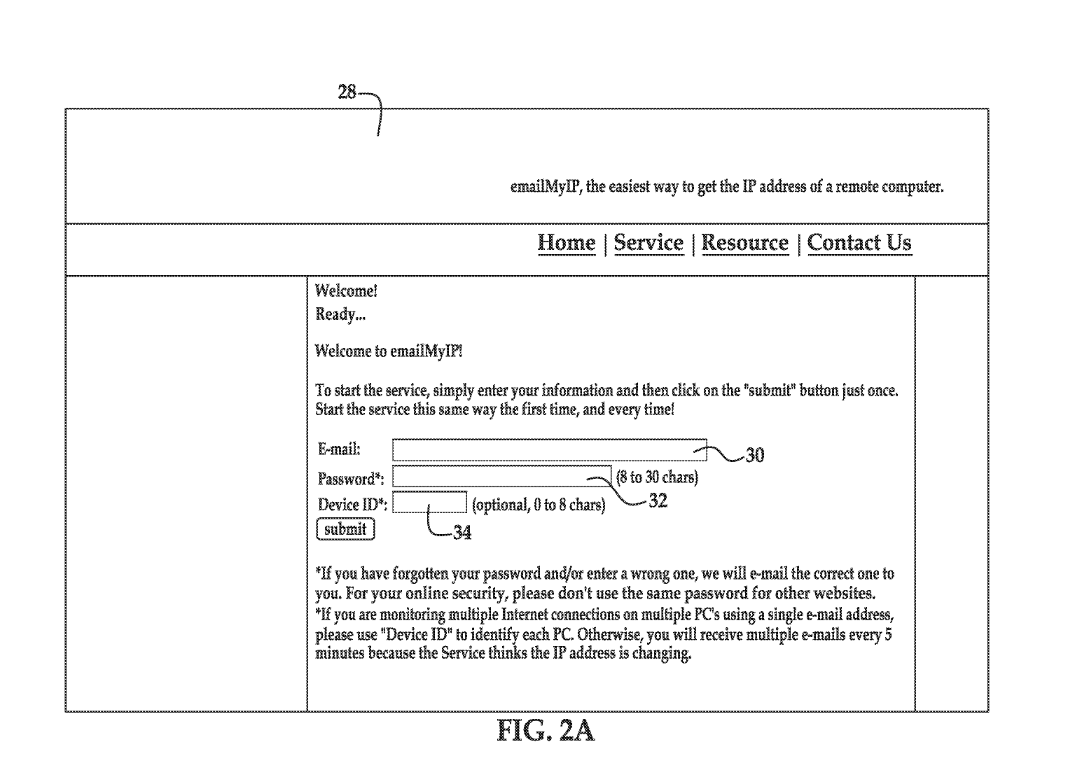

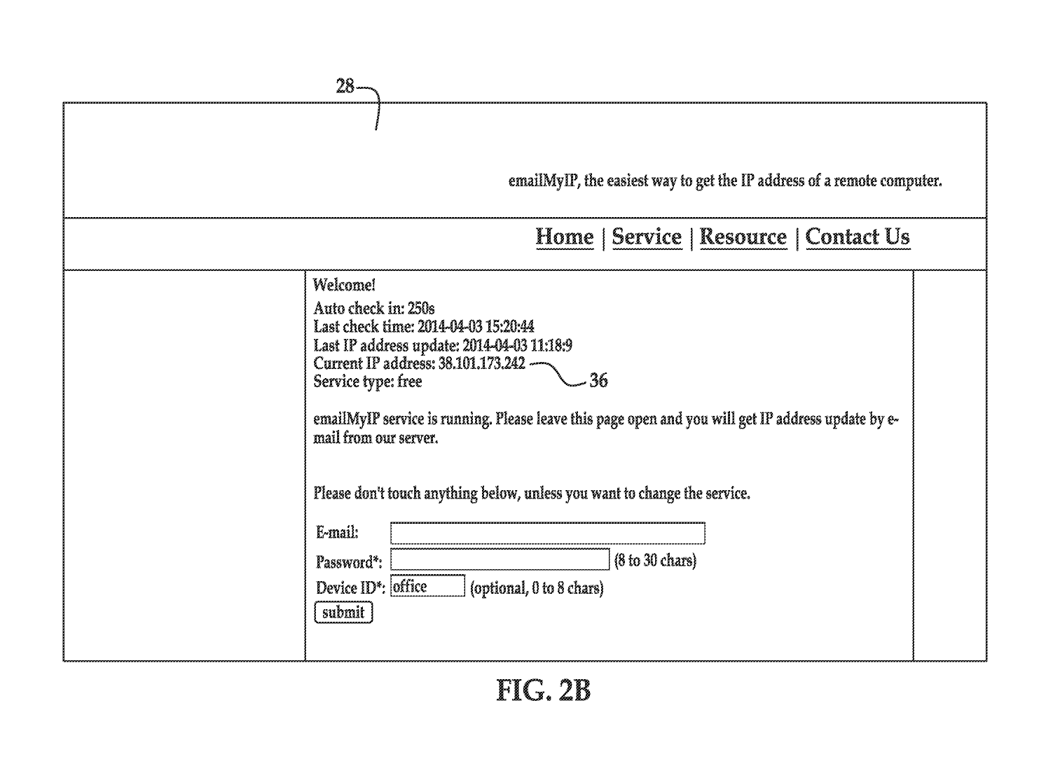

Referring to FIG. 2A, in response to the request, server 22 may be configured to transmit information from server 22 sufficient to generate a graphical user interface (GUI) 28 on a display associated with device 12. The GUI 28 may be generated using browser based scripting languages such as Javascript, Dart SDK from Google, Inc., Script#, CoffeeScript, JSX or ECMAScript Harmony. Server 22 may further be configured to receive authentication information and other information from the user through the GUI 28. In accordance with one embodiment of the invention, the user may provide authentication information in the form of an electronic mail address 30 and a password 32. In accordance with another embodiment of the invention, the user may further provide an identifier 34 for device 12. Providing a device identifier enables the user to monitor the internet protocol addresses for multiple devices 12. It should be understood that the type of information that may be entered, including the authentication information, may vary. For example, as opposed to an electronic mail address, the authentication information may contain other contact information such as a telephone number (and related information such as carrier (e.g., Verizon)) or another unique identifier such as a user's name. When an electronic mail address (or other contact information) is not entered as part of the authentication information, GUI 28 may define an additional data entry field through which appropriate contact information can be entered.

Server 22 may be further configured to retrieve stored information, including stored authentication information, from a memory such as database 20 and to compare the information entered by the user and received from device 12, including the entered authentication information, against the stored information. If the email address does not match any existing email address in memory, server 22 may be configured to create a new entry in the memory containing the email address, password, any device identifier entered by the user and the current internet protocol address obtained from the browser request and to thereafter provide the current internet protocol address to device 14 as described in greater detail below. If the email address in the entered authentication information matches an existing email address in the stored authentication information, but any entered device identifier does not match the device identifier associated with the stored email address, server 22 may likewise be configured to create a new entry in database 20 containing the email address, password, and device identifier entered by the user and the current internet protocol address obtained from the browser request and to thereafter provide the current internet protocol address to device 14 as described in greater detail below. If the email address in the entered authentication information and any entered device identifier match an existing email address in the stored authentication information and associated device identifier in database 20, but the password in the entered authentication information does not match the corresponding password in the stored authentication information, server 22 may be configured to provide a notification to the user. The notification may include an error message displayed on device 12 through the web browser. The notification may also include a message that includes the correct password associated with the entered email address. This message may be sent to the electronic mail address entered by the user or to another location entered by the user or maintained in the database (e.g., a text message to a cellular phone). In an alternative embodiment, a password is not required and is not entered or received by server 20 and the process proceeds based only on a match for the email address and, if entered, device identifier.

Referring to FIG. 2B, if both the email address and, where required, the password in the entered authentication information match an email address and associated password in the stored authentication information and, where applicable, the entered device identifier matches an associated stored device identifier, server 22 may be configured to transmit the current internet protocol address 36 for device 12 (or another device identified by the device identifier entered by the user) to device 12 for display on GUI 28. Server 22 may further be configured to transmit additional information for display on GUI 28 including the particular time at which the current internet protocol address was obtained. If both the email address and the password in the entered authentication information match an email address and associated password in the stored authentication information, server 22 may further be configured to compare the current internet protocol address to any prior internet protocol address for device 12 (or another device identified by the device identifier entered by the user) associated with the email address and password and, where the current and prior internet protocol addresses differ, to overwrite the prior internet protocol address in memory with the current internet protocol address.

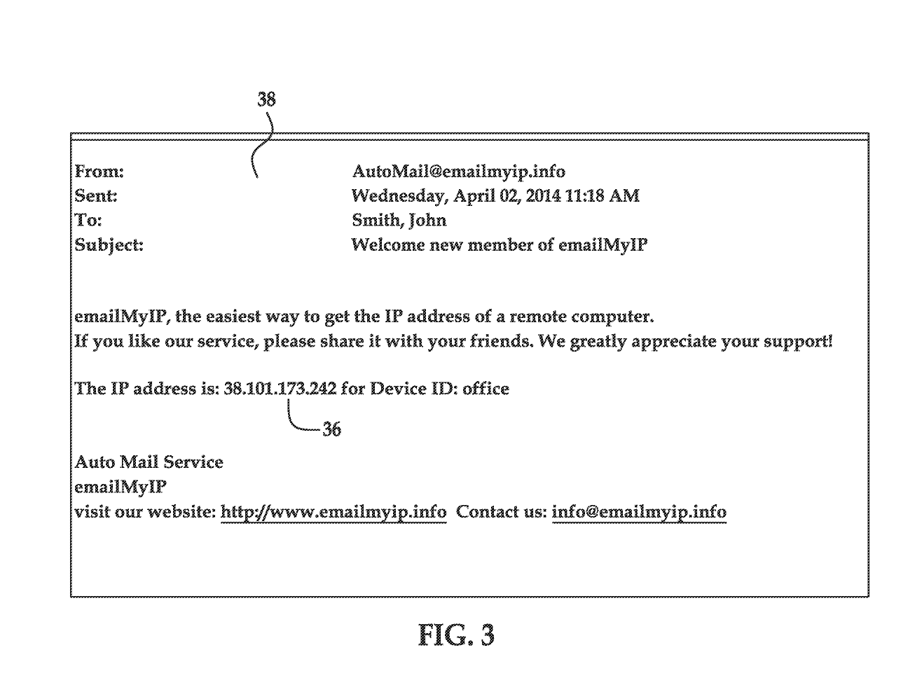

In accordance with the present invention, server 22 is further configured to provide the current internet protocol address for remote computing device 12 to local computing device 14. Providing the current internet protocol address to device 14 may be conditioned on the current internet protocol address being different from the prior internet protocol address, if any, associated with the entered authentication information. Server 22 may provide the current internet protocol address to device 14 in a variety of ways. Referring to FIG. 3, server 22 may be configured to generate an electronic mail message 38 containing the current internet protocol address 36 for device 12 to the electronic mail address entered by the user that may be read on device 14. Alternatively, server 22 may be configured to generate an electronic mail message to the electronic mail address entered by the user and readable on device 14 that contains a hypertext link to a website page maintained by server 22 that contains the current internet protocol address for device 12. Alternatively still, server 22 may be configured to transmit information to device 14 sufficient to generate a website page in a web browser on device 14 wherein the website page displays the current internet protocol address for device 12. In this embodiment, a user may use a web browser on device 14 to access a website page maintained on server 22 and enter authentication information in the manner set forth above as a condition to receiving the current internet protocol address for device 12. In yet another alternative, server 22 may be configured to generate a text message containing the current internet protocol address for device 12 to an email address or phone number entered as part of, or associated with, the entered authentication information.

Server 22 may further be configured to re-execute some or all of the code for receiving a request for a resource from a web browser on device 12, obtaining the current Internet protocol address from the request, and providing the current internet protocol address to device 14. As noted hereinabove, server 22 may be configured to generate a web page in response to an initial request made through the browser on device 12 for display in the browser on device 12. The web page may contain a script (i.e., a computer program consisting of a series of executable instructions that are executed by another computer program (e.g., a scripting engine)) rather than compiled and executed by a processor) that causes the browser to periodically generate requests for resources from server 22. As long as the web browser on device 12 remains open and executing, the web browser on device 12 will periodically generate requests for resources from server 22. As a result, server 22 can continuously monitor the internet protocol address of device 12 and communicate that address to device 14 whenever a change occurs. The same script may include instructions that cause the browser on device 12 to repeat the request if the request does not result in the loading of a page or frame (e.g., iframe) generated by server 22 into the browser on device 12. In this manner, the inventive system will continue to function despite temporary disruptions in network 16 or in the server 22. Server 22 may be understood to be able to receive and respond to requests repeated at predetermined intervals from a browser on device 12, to obtain the current internet protocol address from the request, and provide the current internet protocol address to device 14.

In another alternative embodiment, the GUI 28 may be configured for entry of a domain name or sub-domain (e.g., domain-name.emailMyIP.info). Server 22 may be configured to implement a dynamic domain name service (DDNS) that links the entered domain or sub-domain to the current internet protocol address of the remote computing device 12. Thereafter, server 22 may provide the current internet protocol address to local computing device 14 after entry of the domain name or sub-domain in a web browser on device 14.

A system 10 in accordance with the present invention is advantageous relative to conventional systems for providing internet protocol addresses assigned to remote computing devices 12 because the inventive system does not require downloading and execution of proprietary software on the remote computing device 12. As a result, the inventive system requires less resources (e.g., memory on the remote computing device 12) and is more secure than conventional systems.

While the invention has been shown and described with reference to one or more particular embodiments thereof, it will be understood by those of skill in the art that various changes and modifications can be made without departing from the spirit and scope of the invention.

We claim:

1. A system for providing a current internet protocol address associated with a remote computing device, comprising:
a server configured for connection to said remote computing device over a first network and a local computing device over a second network, said server having a computer program encoded thereon including code for:
receiving a request for a resource from a web browser on said remote computing device;
obtaining said current internet protocol address from said request; and,
providing said current internet protocol address to the local computing device.

2. The system of claim I wherein said computer program includes code for:
retrieving stored authentication information from a memory; and,
comparing entered authentication information received from said remote computing device against said stored authentication information.

3. The system of claim 1 wherein said entered authentication information includes an electronic mail address and a password.

4. The system of claim 3 wherein said entered authentication information further includes a device identifier for said remote computing device.

5. The system of claim I wherein said computer program includes code for comparing said current internet protocol address to a prior internet protocol address for said remote computing device.

6. The system of claim 5 wherein said computer program includes code for writing said current internet protocol address to a memory when said current internet protocol address differs from said prior internet protocol address.

7. The system of claim 5 wherein execution of said code for providing is conditioned on said current internet protocol address being different from said prior internet protocol address.

8. The system of claim 1 wherein said computer program is further configured, in providing said current internet protocol address, to generate an electronic mail message containing said current internet protocol address.

9. The system of claim 1 wherein said computer program is further configured, in providing said current internet protocol address, to generate an electronic mail message containing a link to a website page containing said current internet protocol address.

10. The system of claim 1 wherein said computer program is further configured, in providing said current internet protocol address, to generate a website page in a browser on said local computing device, said website page displaying said current internet protocol address.

11. The system of claim 1 wherein said computer program is further configured, in providing said current internet protocol address, to generate a text message.

12. The system of claim 1 wherein said remote computing devices comprises a router.

13. The system of claim 1 wherein said remote computing device comprises a personal computer.

14. The system of claim 1 wherein said local computing device comprises a personal computer.

15. The system of claim I wherein said local computing device comprises a cellular communications device.

16. The system of claim 1 wherein said computer program further includes code for re-execute said code for receiving, obtaining and providing after a predetermined period of time.

17. An article of manufacture, comprising:
a non-transitory computer storage medium having a computer program encoded thereon for providing a current internet protocol address associated with a remote computing device, said computer program including code for:
receiving a request for a resource from a web browser on said remote computing device;
obtaining said current internet protocol address from said request; and,
providing said current internet protocol address to a local computing device.

18. A method for providing a current internet protocol address associated with a remote computing device, comprising the steps of:
receiving a request for a resource from a web browser on said remote computing device over a first network;
obtaining said current internet protocol address from said request; and,
providing said current internet protocol address to a local computing device over a second network.
